(19) United States
(12) Patent Application Publication
(10) Pub. No.: US 2021/0036500 A1
(43) Pub. Date: Feb. 4, 2021

(54) Systems and Methods of Launch Platform Isolation

(71) Applicant: Clint McCowen, Navarre, FL (US)

(72) Inventor: Clint McCowen, Navarre, FL (US)

(21) Appl. No.: 16/574,081

(22) Filed: Sep. 18, 2019

Related U.S. Application Data
(60) Provisional application No. 62/732,100, filed on Sep. 17, 2018.

(51) Int. Cl. H02G 13/00; B64B 1/50

(52) U.S. Cl. CPC H02G 13/40; H02G 13/20; H02G 13/80; B64B 1/50

(57) ABSTRACT

Ion Harvesting Technology harvests high voltage electricity, including from atmospheric ions. A wire, or conductive tether, may be used to connect ion harvesting material (typically carbon, but including any materials such as metals, metamaterials, or others) located on or near an aerial platform to an anchor point. Because the harvested electricity is typically of high voltage, the electricity may arc between the conductive tether to nearby points of lesser or greater voltage. Such arcing represents a loss of power to the overall system, causing the overall system to be less efficient, or possibly non-operational, and in some cases may cause catastrophic system failure. Electrical isolators may be used to prevent the losses from the arcing.

### CROSS REFERENCE TO RELATED APPLICATIONS

This application claims benefit to U.S. provisional patent application Ser. No. 62/732,100, filed on Sep. 17, 2018, which is incorporated by reference herein.

### TECHNICAL FIELD

The present disclosure is generally related to energy and, more particularly, is related to systems and methods of isolating a launch platform.

### BACKGROUND

The concept of fair weather electricity deals with the electric field and the electric current in the atmosphere propagated by the conductivity of the air. Clear, calm air carries an electrical current, which is the return path for thousands of lightning storms simultaneously occurring at any given moment around the earth. For simplicity, this energy may be referred to as static electricity or static energy.

In a lightning storm, an electrical charge is built up, and electrons arc across a gas, ionizing it and producing the lightening flash. As one of ordinary skill in the art understands, the complete circuit requires a return path for the lightening flash. The atmosphere is the return path for the circuit. The electric field due to the atmospheric return path is relatively weak at any given point because the energy of thousands of electrical storms across the planet are diffused over the atmosphere of the entire Earth during both fair and stormy weather. Other contributing factors to electric current being present in the atmosphere may include cosmic rays penetrating and interacting with the earth's atmosphere, and also the migration of ions, as well as other effects yet to be fully studied.

Some of the ionization in the lower atmosphere is caused by airborne radioactive substances, primarily radon. In most places of the world, ions are formed at a rate of 5-10 pairs per cubic centimeter per second at sea level. With increasing altitude, cosmic radiation causes the ion production rate to increase. In areas with high radon exhalation from the soil (or building materials), the rate may be much higher.

Alpha-active materials are primarily responsible for the atmospheric ionization. Each alpha particle (for instance, from a decaying radon atom) will, over its range of some centimeters, create approximately 150,000-200,000 ion pairs.

While there is a large amount of usable energy available in the atmosphere, a method or apparatus for efficiently collecting that energy has not been forthcoming. Therefore, a heretofore unaddressed need exists in the industry to address the aforementioned deficiencies and inadequacies.

### SUMMARY

Embodiments of the present disclosure provide systems and methods for collecting energy. Briefly described in architecture, one embodiment of the system, among others, can be implemented by at least one ion collection device electrically connected to a support structure; a conductive tether electrically connected to the support structure; a launch platform configured to secure the support structure; and electrical isolators configured to isolate the launch platform from electrical ground.

Embodiments of the present disclosure can also be viewed as providing methods for isolating a launch platform. In this regard, one embodiment of such a method, among others, can be broadly summarized by the following steps: collecting, ionic energy from the atmosphere with ion collectors electrically connected to a support structure; transferring the collected ionic energy from the ion collectors through an electrically conductive tether to a storage device; securing the tether to a launch platform; and electrically isolating the launch platform from electrical ground.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

FIG. 1 is a system diagram of an example embodiment of a system of launch platform isolation.

FIG. 2 is a flow diagram of an example embodiment of a method of launch platform isolation.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Ion Harvesting Technology harvests high voltage electricity, including from atmospheric ions. A wire, or conductive tether, may be used to connect ion harvesting material (typically carbon, but including any materials such as metals, metamaterials, or others) located on or near an aerial platform to an anchor point. In an example embodiment, the anchor point is a mechanical winch, but it may be any type of anchor point located above, near, on, or in the planet's ground. In an alternative embodiment, the anchor point includes attachment to aircraft, vehicles, drones, space stations, and space elevators, among others whether or not they are connected or related to planet ground. Because the harvested electricity is typically of high voltage, the electricity may arc between the conductive tether to nearby points of lesser or greater voltage. Such arcing represents a loss of power to the overall system, causing the overall system to be less efficient or possibly non-operational, and in some cases may cause catastrophic system failure.

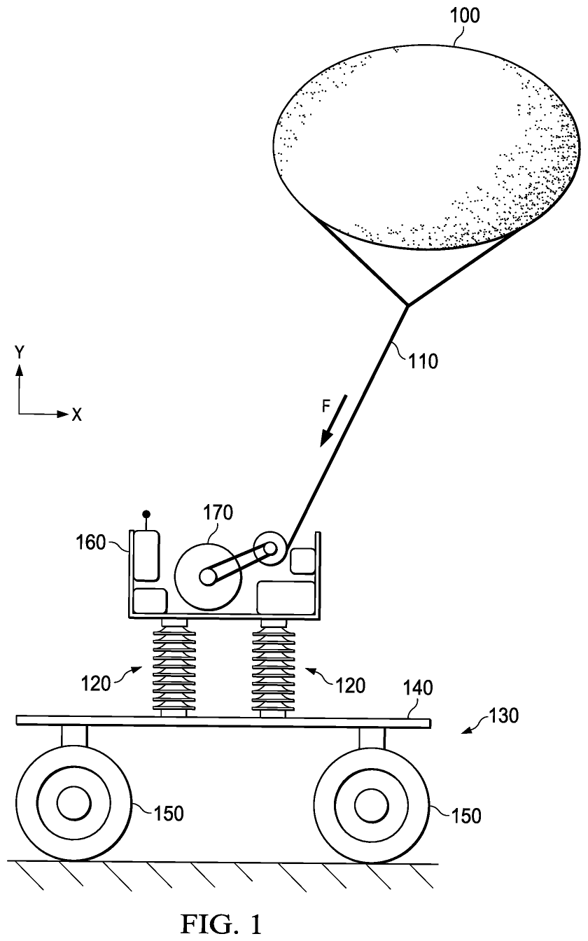

FIG. 1 provides a system diagram of an example embodiment of a system of launch platform isolation. Aerial device 100 comprising ion harvesting material is connected to platform 130 with conductive tether 110. Platform 130 may comprise one or more of wireless transmitter 160, winch 170, electrical isolators 120, table 140, and wheels 150. Other possible elements include, but are not limited to, motor, gearbox, resistors, capacitors, batteries, energy storage modules, motor controller, wireless data transmitter, electrical measurement device, data recorders, and other support equipment.

To avoid the arcing problem, conductive tether 110 may be located away from objects of lesser or greater voltage potentials. For example, if winch 170 on which conductive tether 110 is rolled is not electrically isolated from the planet's ground (or artificial ground of greater or lesser potential), then arcing may occur. Utilizing a standard aerostat launching platform may not be suitable, nor compatible, with Ion Harvesting Technology as winch 170 and/or launch platform 130 may not be adequately electrically isolated from the planet's ground, potentially causing arcing.

In an example embodiment, winch 170 or other anchor device to which tether 110 is connected (including the ‘drum’ on which tether 170 is rolled) is electrically isolated from the planet's ground. Additionally, any mechanical or electrical connections to winch 170 may be likewise electrically isolated from the planet's ground. Failure to provide adequate electrical isolation to winch 170 or drum or other anchor devices connected to conductive tether 110 may result in catastrophic failure or undesirable operation of the entire Ion Harvesting System.

Example embodiments provided herein may utilize electrical isolators similar, but not necessarily identical, to electrical isolators used to provide electrical isolation to high voltage transmission lines on Earth grid systems. However, other designs are also included in this disclosure. Alternative embodiments include any rope, cable, pipe, straps, extensions, or the like or liquids, gases, materials, or metamaterials that possess sufficient electrical resistivity to prevent arcing or electrical leakage.

In an alternative embodiment, the winch support structure includes a point to which electrical isolation is provided.

In an alternative embodiment, launch platform 130, including winch 170, is electrically isolated from the planet's ground through driving or positioning the launch vehicle on another platform or area designed to provide electrical isolation to whatever is placed on it, including winch 170 or other anchor point with or without a launch platform or vehicle. Examples include an area, surface, deck, platform, or mat onto which launch platform 130 is positioned (or driven or towed) so as to provide a surface of high electrical resistivity to provide enhanced electrical isolation to launch platform 130, including winch 170. The insulating surface may be affixed or connected, permanently or temporarily, to launch platform 130, or winch 170, or any component thereof in order to provide suitable isolation.

Another example embodiment includes extensions made of high electrical resistivity used to separate or lift launch platform 130 away from the planet's surface. The definition of planet's ground herein, includes any form of ground, water, liquid, marsh, ice, mud, or any natural or man-made surface.

Another example embodiment, includes utilizing liquid, gas, or metamaterial of sufficient electrical resistivity to prevent arcing or electrical leakage on which winch 170 or launch platform 130 (anchor) may be placed upon or to float upon or in, thereby providing electrical isolation from the planet's ground, ocean, or surface.

An example embodiment of aerial platform 100 includes but is not limited to aerostats, balloons, kites, helikites, towers, poles, buildings, objects above the planet, in the atmosphere, or in space to which tether 110 is connected (including but not limited to a space elevator), and any device or means of providing altitude greater than 1 cm above the planet's surface or combinations thereof.

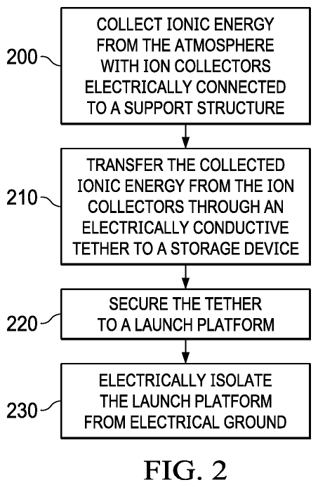

FIG. 2 provides a flow diagram of an example embodiment of a method of launch platform isolation. In block 200, ionic energy is collected from the atmosphere with ion collectors electrically connected to a support structure. In block 210, the collected ionic energy is transferred from the ion collectors through an electrically conductive tether to a storage device. In block 220, a tether is secured to a launch platform. In block 230, the launch platform is electrically isolated from electrical ground.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. A system comprising:
at least one ion collection device electrically connected to a support structure;
a conductive tether electrically connected to the support structure;
a launch platform configured to secure the support structure; and
electrical isolators configured to isolate the launch platform from electrical ground.

2. The system of claim 1, wherein the ion collection device comprises at least one of carbon, graphite, graphene, and silicene.

3. The system of claim 1, wherein launch platform comprises a winch configured to manipulate the altitude of the support structure.

4. The system of claim 1, wherein the support structure comprises an aerial platform, the aerial platform comprising at least one of an aerostat, balloon kite, helikite, tower, pole, and building.

5. The system of claim 1, wherein the electrical isolator at least one of an electrical, mechanical, and optical isolation barrier.

6. The system of claim 1, wherein the electrical isolator comprises at least one of rope, cable, pipe, straps, extensions, liquids, gases, material, and metamaterial configure to prevent arcing or electrical leakage.

7. The system of claim 3, wherein the electrical isolator is provided by positioning the launch platform in an area configured to provide electrical isolation to an item in the area.

8. A method comprising:
collecting ionic energy from the atmosphere with ion collectors electrically connected to a support structure;
transferring the collected ionic energy from the ion collectors through an electrically conductive tether to a storage device;
securing the tether to a launch platform; and
electrically isolating the launch platform from electrical ground.

9. The method of claim 8, wherein the ion collectors comprise at least one of at least one of carbon, graphite, graphene, and silicene.

10. The method of claim 8, further comprising manipulating the altitude of the support structure with a winch.

11. The method of claim 8, wherein the support structure comprises an aerial platform, the aerial platform comprising at least one of an aerostat, balloon kite, helikite, tower, pole, and building.

12. The method of claim 9, wherein electrically isolating the launch platform comprising isolating with at least one of an electrical, mechanical, and optical isolation barrier.

13. The method of claim 10, wherein electrically isolating the platform comprises implementing at least one of rope, cable, pipe, straps, extensions, liquids, gases, material, and metamaterial configure to prevent arcing or electrical leakage.

14. The method of claim 8, further comprising positioning the launch platform in an area configured to provide electrical isolation to an item in the area.

15. A system comprising:
a launch platform configured to secure a support structure supporting ionic energy collectors; and
electrical isolators configured to isolate the launch platform from electrical ground.

16. The system of claim 15, wherein the ion collectors comprise at least one of at least one of carbon, graphite, graphene, and silicene.

17. The system of claim 15, further comprising a winch configured to manipulate the altitude of the support structure.

18. The system of claim 15, wherein the support structure comprises an aerial platform, the aerial platform comprising at least one of an aerostat, balloon kite, helikite, tower, pole, and building.

19. The system of claim 15, wherein the electrical isolators comprise at least one of an electrical, mechanical, and optical isolation barrier.

20. The system of claim 15, wherein the electrical isolators comprise at least one of rope, cable, pipe, straps, extensions, liquids, gases, material, and metamaterial configure to prevent arcing or electrical leakage.
